(19) United States
(12) Patent Application Publication
(10) Pub. No.: US 2026/0056910 A1
(43) Pub. Date: Feb. 26, 2026

(54) CB Echo Link

(71) Applicant: Devounte Ho-Hing, Daytona Beach, FL (US)

(72) Inventor: Devounte Ho-Hing, Daytona Beach, FL (US)

(21) Appl. No.: 18/812,699

(22) Filed: Aug. 22, 2024

(51) Int. Cl. G06F 13/42

(52) U.S. Cl. CPC G06F 13/4282; G06F 2213/0042; G06F 2213/4004

(57) ABSTRACT

This cutting-edge solution revolutionizes the way solid-state drives (SSDs) are connected by eliminating the need for manual plugging. Its innovative technology allows for the consolidation of multiple SSDs into a single unit, streamlining workflows and boosting productivity. With a single-cord connection, users can effortlessly link numerous SSDs, reducing cable clutter and simplifying the setup process. Furthermore, this method integrates seamlessly with the back of a laptop, saving valuable desk space and remaining inconspicuous when not in use. This user-friendly solution is both practical and efficient, minimizing the need for constant manual setup and providing easy access to multiple SSDs whenever necessary.

### BACKGROUND

### Field of the Invention

Embodiments of the present invention relate to solid state drives (SSDs) and more particularly relate to convenient method for connecting multiple SSDs without the need for manual plugging.

### Description of the Related Art

Solid-state drives (SSD) are a form of data storage that use a solid-state memory to store data. Examples of solid state memory include static random access memory (SRAM), dynamic random access memory (DRAM), and flash memory. Unlike conventional disk drives that include several moving components, an SSD does not have moving parts as the data are electronically stored and not stored on a rotating disk. Since an SSD does not store data on a rotating disk. SSDs experience fewer mechanical failures than conventional hard disk drives having many moving parts. Additionally, SSDs have a faster startup time than conventional hard disk drives as they do not require time for a disk to spin up to a particular speed in order for data to be written to or read from the disk.

An SSD may comprise a plurality of NAND flash memory cells or DRAM memory cells. In some implementations, NAND flash memory is a single-level cell (SLC) that stores a single bit of data per cell. Multi-level cell flash memories (MLC) store two bits of data per cell. Accordingly, MLC flash has a higher density than that of SLC flash, and due to its lower price and higher capacity, MLC flash is more commonly used in an SSD than SLC flash.

By looking at prior art multiple advancements have been seen in similar regards. For instance, a U.S. Pat. No. 1,052,1156B2 relates to apparatus and method of managing multi solid state disk system. The management apparatus of a multi-solid state disk (SSD) system implemented by a computer is provided. The management apparatus of the multi-SSD system may include a first SSD group including a plurality of SSDs arranged in rows or columns and configured to execute a received write command using segments in the plurality of SSDs, a second SSD group including a plurality of SSDs arranged in rows or columns and configured to execute a read command for valid data in the plurality of SSDs, and a manager configured to copy a valid page in the second SSD group while a write command for the first SSD group being executed and to erase all data in the second SSD group when the copying is completed.

A U.S. Pat. No. 9,510,474B2 relates to Solid state drive (SSD) assembly method. The solid state drive (SSD) assembly and an assembly method for solid state drives, which does not require using screws. The assembly method includes aligning a printed circuit board with a first cover and a second cover, the first cover having pre-installed standoffs on an inner surface thereof. The printed circuit board and the second cover respectively having a first set of through-holes, and the first set of through-holes correspond to the standoffs. The assembly method further includes placing the printed circuit board between the first and second covers, thereby exposing an end portion of each of the standoffs in the through-holes of the second cover, and deforming the end portion of each of the standoffs about the through-holes, thereby fastening the first and second covers with one another.

A U.S. Pat. No. 2,009,0300258A1 relates to Ssd with a channel multiplier. The integrated circuit includes a first serial advanced technology attachment (SATA) channel, a plurality of second SATA channels, and a channel multiplier. The first SATA channel is configured to be coupled to a corresponding serial data bus of a host device. Each of the plurality of SATA channels is configured to be coupled to a respective separate memory device channel. The channel multiplier is configured to couple the first SATA channel to each of the plurality of second SATA channels.

A U.S. Pat. No. 2,017,0285967A1 relates to Multi-ware smart ssd. The solid state drive (SSD) includes a first memory; a second memory of a different type than the first memory; a third memory of a different type than the first memory and of a different type than the second memory; and a weight determiner for determining a weightage of externally supplied data, prior to storing the data in any of the first memory, the second memory, or the third memory, and for assigning the data to one of the first memory, the second memory, or the third memory based on the determined weightage.

A U.S. Pat. No. 9,430,326B2 relates to multiple ECC codeword sizes in an SSD. The Methods for writing multiple codewords having multiple sizes to a solid-state device are provided. In one aspect, a method includes receiving a plurality of host data units for storage in a solid-state non-volatile memory. The method includes dividing the plurality of host data units among a plurality of data payloads, wherein a first data payload comprises a first host data unit and a second data payload comprises a portion of a second host data unit. The method includes encoding the first data payload into a first codeword having a first codeword size. The method includes encoding the second data payload into a second codeword having a second codeword size, the second codeword size being different from the first codeword size. The method includes writing the first codeword and the second codeword to a first page in the solid-state non-volatile memory. Systems and machine-readable media are also provided.

There are multiple inventions that have been proposed in prior art regarding bringing advancement and enhanced utility. However, the utilization of these systems in daily life are quite cumbersome and ineffective. Also, the features of this utility system are quite limited.

The instant invention attempts to overcome deficiencies of the prior art by providing a convenient method for connecting multiple SSDs without the need for manual plugging every time, thus making it more efficient and time-saving.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The objective of the invention is to offer a convenient means of linking multiple solid-state drives (SSDs) without the need for manual plugging.

It is further the objective of the invention to provide a safe and durable assembly that utilizes a unique technology to consolidate multiple existing SSDs into a single unit, streamlining the connection process.

It is moreover the objective of the invention to provide flexibility and enhanced connectivity to user wherein a single cord connection enables the connection of multiple SSDs and thus reducing cable clutter and simplifying the overall setup.

It is another object of the present invention to provide a new and improved assembly wherein integration with Laptop makes it a space-saving solution that remains hidden and unobtrusive when not in use.

It is a further object of the present invention to provide a new and improved assembly which is of a durable and reliable construction. The invention's design enhances practicality by minimizing the need for constant manual setup, allowing users to have easy access to multiple SSDs whenever required, making it a user-friendly solution.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, FIGURES, and Claims.

### BRIEF DESCRIPTION OF THE DRAWINGS

The accompanying FIGURES, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows detailed view of claimed assembly as per preferred embodiments of the invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

More specifically, the present invention as per its preferred embodiments a convenient method for connecting multiple SSDs without the need for manual plugging is provided.

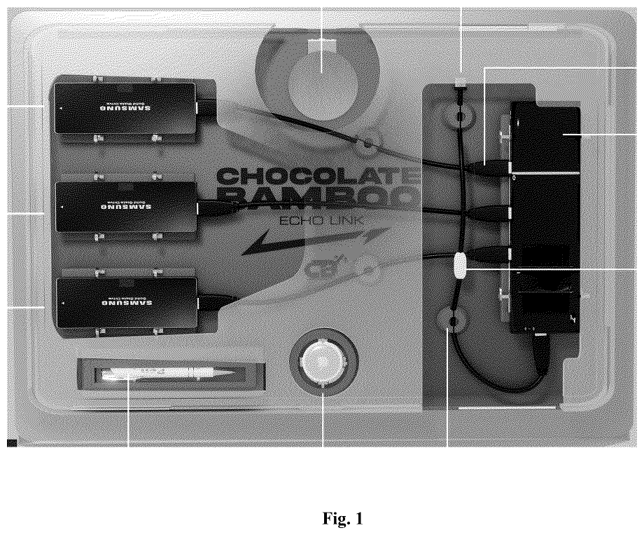

A SSD generally includes a printed circuit board assembly (PCBA) within a metallic housing. FIG. 1 is an exploded illustration of a SSD according to the related art. The SSD according to the related art includes a PCBA, which is inside a housing. The housing comprises an upper cover a and a lower cover. The upper cover, the bottom cover and the PCBA respectively have a first set of corresponding through-holes. Further, the lower cover and the PCBA respectively have a second set of corresponding through-holes.

Memories are provided on the PCBA. The PCBA is affixed onto the lower cover by tightening screws into the second set of through-holes. With the PCBA affixed onto the lower cover, the housing is then closed by affixing together the upper and lower covers and by tightening screws into the first set of through-holes. Therefore, the assembly of the SSD according to the related art requires a large number of screws and labor for tightening the screws.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A method for connecting multiple SSDs without the need for manual plugging comprising:
Circuit board;
Cord placeholder;
Docking station;
USB Type C Male to USB Type C Male;
Air Tag;
Cable Management;
USB Type C Female to Female adapter Extender;
USB type C Male to USB;
SSD Drives; and,
USB Type C Male to USB.
An assembly for connecting multiple SSDs as per claim 1, wherein multiple SSDs can be connected through a single assembly.
An assembly for connecting multiple SSDs as per claim 1, wherein unique technology provides consolidation of multiple existing SSDs into a single unit, streamlining the connection process.
An assembly for connecting multiple SSDs as per claim 1, wherein the connection of multiple SSDs is done with a single cord thus reducing cable clutter and simplifying the overall setup.
An assembly for connecting multiple SSDs as per claim 1, wherein the assembly provides integration with the back of a laptop thus making it a space-saving solution that remains hidden and unobtrusive when not in use.
